(19) United States
(12) Patent Application Publication
(10) Pub. No.: US 2005/0195773 A1
(43) Pub. Date: Sep. 8, 2005

(54) Method and apparatus for dynamic network prefix allocation for a mobile router

(76) Inventors: George Popovich, Palatine, IL (US); Tyrone D. Bekiares, Chicago, IL (US)

Correspondence Address: MOTOROLA, INC., 1303 EAST ALGONQUIN ROAD, IL01/3RD, SCHAUMBURG, IL, 60196, US

(21) Appl. No.: 10/784,363

(22) Filed: Feb. 23, 2004

(51) Int. Cl. H04Q 7/24

(52) U.S. Cl. 370/338

(57) ABSTRACT

In a system (100) including at least one mobility server (50), at least one mobile router (20) and a plurality of hosts (30,40), a method for network prefix allocation that includes the steps of: detecting a need for at least one network prefix for a mobile router (20); sending a registration request message to a mobility server (50) that includes a request to allocate the at least one network prefix to the mobile router (20); and receiving a registration reply responsive to the registration request that includes at least one allocated network prefix, wherein the at least one allocated network prefix is reserved for the mobile router (20) for a first time period.

### FIELD OF THE INVENTION

The present invention relates generally to mobility management systems and more specifically to a method and apparatus for dynamically allocating a network prefix to a mobile router.

### BACKGROUND OF THE INVENTION

There has been an increasing use of mobility management systems that utilize a client/server approach to mobility management of hosts that are coupled to the system. One goal of these systems is to provide a solution for seamless mobility on a network such as, for instance, the global Internet or a private network, that is scalable, robust and secure, and that allows roaming hosts or “mobile nodes” such as, for instance, radios, phones, laptops, PDAs, etc., to maintain ongoing communications while changing their point of attachment to the network. Specifically, each mobile node is always identified by its home address (regardless of its current point of attachment to the network), which provides information about its point of attachment to a home network. However, when the mobile node is connected to the network outside of its home network, i.e. when visiting a foreign network or a foreign domain, the mobile node is also associated with a care-of address that provides information about its current point of attachment. Those of ordinary skill in the art should realize that the term “care-of address” is not meant to be limited to any particular client/server mobility mechanism but covers other terms used in the art that describe a topologically correct address such as, for instance, a “point-of-presence address.”

Typically, such systems include a plurality of mobility servers and edge mobility agents that utilize a protocol for facilitating the mobility management of the mobile nodes. The mobility server is an entity, for instance a router, on the mobile node's home network that tunnels datagrams (also known in the art as data packets) for delivery to the mobile node when it is away from home, and maintains current location information for the mobile node. The edge mobility agent is an entity, for instance a router, on the mobile node's visited network that provides routing services to the mobile node when the mobile node is registered with the edge mobility agent.

A mobile internet protocol (“Mobile IP”) enabled system is one well known example in the art of a mobility management system. Mobile IP provides for a registration process for registering the care-of address with a mobility server called a home agent (“HA”) whose point of attachment, i.e., its IP address, is in the mobile node's home network. Those of ordinary skill in the art should realize that the term “registration” is not meant to be limited to any particular client/server mobility mechanism but covers other terms used in the art that may, for instance, be associated with a proprietary system, that describe the process of a mobile node updating its mobility server with its current location information.

The registration process typically comprises a registration request message from the mobile node to the home agent and a registration reply message from the home agent to the mobile node that is responsive to the registration request message and that indicates whether or not the registration process was successful. Registration is what enables the home agent to send the datagrams destined for the mobile node, i.e., outbound datagrams, through a tunnel to the care-of address. After arriving at the end of the tunnel, each datagram is then delivered to the mobile node.

Registration may be further facilitated by an edge mobility agent called a foreign agent (“FA”) whose point of attachment is in the visited network and whose IP address may be used as the care-of address for the mobile node. The foreign agent detunnels and delivers datagrams to the mobile node that were tunneled by the mobile node's home agent. For datagrams sent by the mobile node, i.e., inbound datagrams, the foreign agent may serve as a default router for registered mobile nodes. The mobile node may alternatively obtain a co-located care-of address for the visited network, for instance via a foreign agent or an edge router, and register that care-of address with its home agent. Thus, a foreign agent may or may not be present in the visited network. Moreover, even in the presence of a foreign agent, the registration may or may not be facilitated by the foreign agent on the visited network when the mobile node is operating using a co-located care-of address.

A mobile node can be a router, i.e., a mobile router (“MR”), which is responsible for the mobility of one or more entire networks or sub-networks (also referred to herein as “subnets”) moving together, perhaps on an airplane, a ship, a train, an automobile, etc. The subnets for which the mobile router is responsible are generally known in the art as being located “behind” the mobile router. The hosts connected to a subnet behind the mobile router and that receives mobility management services from the mobile router (i.e., is served by the mobile router) may themselves be fixed or stationary nodes, mobile nodes or routers. A mobile router may act as a foreign agent and provide a foreign agent care-of address to hosts connected to a subnet behind the mobile router, or the mobile router may, alternatively, facilitate in co-located care-of addresses being assigned to these hosts.

The subnets located behind a mobile router are typically statically provisioned, in much the same way as subnets are allocated in a fixed infrastructure. This generally results in one or more permanent network prefixes (each corresponding to a range of IP addresses that are topologically similar) being allocated to each mobile router in a system, wherein each network prefix corresponds to a subnet behind the mobile router. Each statically allocated subnet may then be tied to the corresponding mobile router using statically preconfigured routing, e.g., in a routing table, in for instance the home agent if it is configured as a router, or in the mobile router or both. Thus, as the mobile router moves from one network attachment point to another, the mobile router may either advertise reachability to these subnets directly through dynamic routing protocols, or may use standard Mobile IP (defined herein as the implementation of Mobile IP in accordance with Request for Comment (“RFC”) 3344, i.e., MIPv4) to advertise reachability.

The issue of scalability is a concern with this static network prefix allocation, especially in a system that includes a large number of mobile routers, each one being a candidate for a mobile network. For example, consider a customer (perhaps a public safety customer) that has ten of thousands of vehicles, each of which may house a mobile router. The in-car mobile routers may serve one or more hosts, such as, for instance, radios, phones, laptops, PDAs, etc. In accordance with this static network prefix allocation, each vehicle would require at least one in-car network prefix permanently reserved for it, whether the vehicle is in service or not. This rapid depletion of network prefixes along with the added need to allocate infrastructure network prefixes for the wireless communication infrastructure (which may consist of thousands of sites) may quickly deplete the IP addressing space in IPv4 based packet networks.

Dynamic Subnet Configuration Protocol (“DSCP”) is one way known in the art to manage subnets. In accordance with DSCP, which is built upon a client/server model, a DSCP client, typically an administrative server, requests a temporary network prefix from a DSCP server. The server then leases the network prefix to the client for a fixed amount of time. A shortcoming of this approach is that it is not designed to be implemented with Mobile IP or similar mobility management protocols. Thus, DSCP does not facilitate the movement of a dynamically allocated network prefix from one network point of attachment to another, thereby being virtually unusable with mobile routers. In essence, each time the mobile router moves to a different point of attachment and has to register a different care-of address, the mobile router would need to be assigned a different network prefix, which could result in lost datagrams and a lack of compatibility with certain applications. Another shortcoming of the DSCP solution is that there is no provisioning for a dynamically allocated network prefix to be advertised to the rest of the network. This further supports a lack of compatibility between DSCP and mobile routers since without such advertisement means, packets destined to hosts served by a mobile router could not reach those hosts.

Thus, there exists a need for a method and apparatus for dynamically allocating a network prefix to a mobile router that does not have to change as the mobile router changes its point of attachment to the network and that provides for the advertising of each allocated network prefix to the rest of the network.

### BRIEF DESCRIPTION OF THE FIGURES

A preferred embodiment of the invention is now described, by way of example only, with reference to the accompanying figures in which:

FIG. 1 illustrates an exemplary mobility management system that may be used to implement an embodiment of the present invention;

FIG. 2 illustrates the registration signaling operation of a mobile router implementing dynamic network prefix allocation in accordance with an embodiment of the present invention; and

FIG. 3 illustrates the registration signaling operation of a mobility server implementing dynamic network prefix allocation in accordance with an embodiment of the present invention.

### DETAILED DESCRIPTION OF THE INVENTION

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

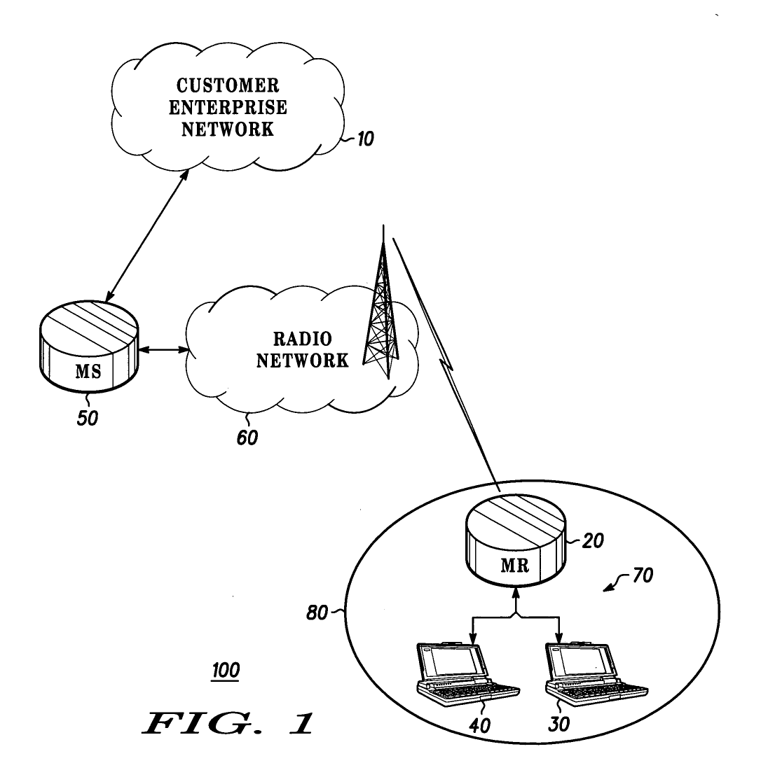

FIG. 1 illustrates an exemplary mobility management system 100 that may be used to implement an embodiment of the present invention. FIG. 1 includes a home network 10, e.g. a Customer Enterprise Network, for a mobile router 20. Mobile router 20 has a home address associated with its home network 10 such that when mobile router 20 is attached to the network in its home network, datagrams can readily reach mobile router 20 using, for example, standard Mobile IP. The mobile router may be implemented as a hardware device (as illustrated in FIG. 1) but may also be, and is typically, implemented in software that may be stored in a suitable storage device, wherein the software is implemented in a suitable processor device.

Coupled to mobile router 20 is a host 30 and a host 40. This coupling may be by way of, for instance, a wired cable connection or a short range wireless communication network transport. One or both of host 30 and 40 may be, for instance, a stationary or Local Fixed Node (“LFN”), i.e., a node that is not configured for mobility management. Alternatively, one or both of hosts 30 and 40 may be a mobile node or a router. Hosts 30 and 40 are illustrated as laptops in FIG. 1. However, those of ordinary skill in the art will recognize that hosts 30 and 40 may be other IP enabled devices including, but not limited to, a radio, a phone, a global positioning system (“GPS”) receiver and a PDA. Those of ordinary skill in the art will further realize that host 30 may be a different type of device from host 40 and that system 100 may include more or fewer than two hosts coupled to mobile router 20.

System 100 further includes a mobility server (“MS”) 50 for mobile router 20, which may for instance be a home agent, which is also in network 10. Mobile router 20 must register a care-of address with mobility server 50 when its point of attachment is in a foreign network (i.e., a network other than network 10) such as, for instance, a network 60, so that mobility server 50 may tunnel datagrams to mobile router 20 at that care-of address. Mobility server 50 may also be the mobility server for hosts 30 and 40, or hosts 30 and 40 may have a mobility server that is different from mobility server 50.

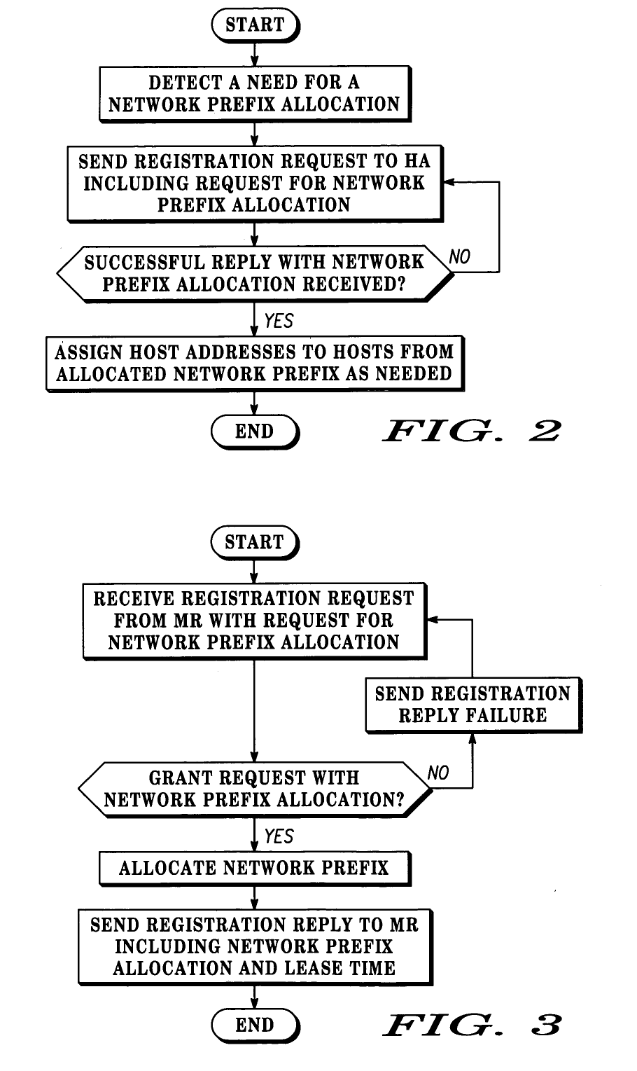

Mobile router 20 and the hosts coupled to it (i.e., hosts 30 and 40) comprise what is typically known in the art as a mobile network (or mobile platform) 80. For example, if the present invention is utilized by a public safety customer, mobile network 80 may, for instance, be included or housed in a public safety vehicle 70 as illustrated in FIG. 1. However, those of ordinary skill in the art should realize that the present invention may be implemented by different types of customers, whereby mobile network 80 might alternatively be housed in other moving vehicles including, but not limited to, airplanes, ships or trains. Mobile network 80 must be assigned and tied to at least one network prefix that will identify at least one subnet located behind the mobile router 20 to which hosts 30 and 40 will be attached for sending and receiving datagrams. FIGS. 2 and 3 each describe a method in accordance with the present invention for dynamically allocating a network prefix, for example from a pool of available network prefixes, first from the perspective of a mobile router (FIG. 2) and then from the perspective of a mobility server (FIG. 3).

FIG. 1 is only representative of a mobility management system, and therefore, shows only a limited number of hosts and a single mobile router and mobility server for purposes of ease of illustration. However, it should be understood by those of ordinary skill in the art that typically the system might include a plurality of mobile routers each of which may serve one or more hosts. In addition, there are typically many more local networks and local domains and mobility servers included in the system, and the system may further include a plurality of edge routers and edge mobility agents. It should be further understood by those of ordinary skill in the art that the functionality of the mobile router and the mobility server (including the functionality described in and by reference to FIGS. 2 and 3) may be implemented in software or hardware, although the functionality is typically implemented in software.

FIG. 2 illustrates the registration signaling operation of a mobile router, e.g., mobile router 20, implementing dynamic network prefix allocation in accordance with an embodiment of the present invention. In the present embodiment, the mobile router is implementing the invention in accordance with Mobile IP. However, those of ordinary skill in the art will realize that the present invention may just as easily be implemented using a mobile router providing IP subnet mobility to hosts utilizing a different, possibly proprietary, client-server based mobility management mechanism.

As stated earlier, the present invention eliminates the need to statically allocate network prefixes to a mobile router. Thus, it may be assumed that when the mobile router is not in use or service, e.g., when it is not powered-up, the mobile router may not have a network prefix allocated for its use. Accordingly, upon power-up, or at any time that the mobile router is not assigned a subnet, the mobile router may request one or more network prefixes from the home agent, for instance, as a function of the number of hosts that the mobile router anticipates having to service. Each network prefix may typically be assigned from a pool of network prefixes available for allocation by the home agent.

Returning to FIG. 2, the mobile router may detect a need for a network prefix allocation. For instance upon power-up, the mobile router may detect based upon agent advertisements, that it has moved from its home network point of attachment and that it accordingly needs an assigned network prefix. Alternatively, upon power-up the mobile router may detect a need for a network prefix allocation based upon an assumption that there are no subnets behind it when it is not powered-up. In yet another embodiment, the mobile router may detect a need for an additional network prefix to accommodate the number of hosts that it serves.

Once the need for a network prefix allocation is detected, the mobile router sends a Mobile IP registration request message to its home agent in accordance with standard Mobile IP. This registration request may, for instance, be relayed to the home agent via a foreign agent. In accordance with the present invention, the registration request message also includes an added proprietary extension requesting that one to N subnets, including an address and a prefix, be assigned by the home agent on behalf of the mobile router. Alternatively, the mobile router may request one or more specific network prefixes using added extensions to the registration request message. This would, for instance, enable the mobile router to request its current subnet assignments when it associates with a new home agent and enables compatibility with applications which require static or semi-static subnet allocations.

The registration request may also optionally include a request for a lease time, for instance using a lease time field in the registration request message. The lease time may, for instance, range from one time unit to infinity and indicates a specific period of time that the mobile router wants the home agent to reserve the network prefix before it can be made available to other mobile routers. For example, where a public safety customer implements the present invention, the mobile router may use the lease time field to request that a dynamically assigned subnet be reserved for the mobile router's exclusive use for the length of an officer's shift. The lease time is not required to correspond to the lifetime of the registration request and is not affected by the mobile router changing its point of attachment. This ensures that during the lease time, the mobile router will not be assigned a new network prefix, even if the mobile router's Mobile IP registration expires for a period of time (for example while a vehicle is out of the coverage area). Otherwise, the hosts in the vehicle could be forced to obtain new IP addresses at an inconvenient time, for example in the middle of an officer's shift, which may cause issues with certain applications and a loss of datagrams.

If the home agent can accommodate the mobile router's registration request, the mobile router receives a successful registration reply that includes at least one allocated network prefix with an indication in the reply of the lease time period. Otherwise, upon receiving an unsuccessful registration reply, the mobile router can re-attempt the registration process. The lease time period may be one requested by the mobile router. Alternatively, if the mobile router did not request a specific lease time, one may be assigned by the home agent that may be, for instance, a default lease time period. Once the mobile router receives an allocated network prefix, the mobile router may begin allocating host (i.e., IP) addresses to hosts that are coupled to the mobile router and that, for instance, have attached to one or more interfaces that are conventionally mapped to the allocated network prefix. Where a host has mobility management capabilities, i.e., is itself a mobile node, its host address allocation may be used as a co-located care-of address. Alternatively, where a host is a stationary node, its host address may be used as a home address.

Host address allocations may, for instance, be performed by having the mobile router support standard Dynamic Host Configuration Protocol (“DHCP”) Server services on these interfaces in accordance with RFC 1541. DHCP is well known in the art and will not be discussed in detail here for the sake of brevity. The mobile router may be further configured to extend the lease of a subnet through a subsequent registration request to the home agent prior to the expiration of the initial lease time period to prevent the network prefix from being returned to the pool of available network prefixes. Moreover, the mobile router may be further configured for allocating and revoking a temporary IP address via standard DHCP. This would be useful, for instance, where a host that is coupled to a mobile router requests an IP address via DHCP before the mobile router has registered with its home agent to receive a network prefix. In this case, the mobile router could allocate to the host a temporary “dummy” IP address until the mobile router is allocated, in accordance with embodiments of the present invention, a network prefix. At that point, the mobile router could revoke the temporary IP address and assign a different IP address from the mobile router's newly allocated network prefix.

FIG. 3 illustrates the registration signaling operation of a mobility server, e.g., mobility server 50, implementing dynamic network prefix allocation in accordance with an embodiment of the present invention. In this embodiment, the mobility server is a home agent implementing the invention in accordance with Mobile IP. However, those of ordinary skill in the art will realize that the present invention may just as easily be implemented using a mobility server providing IP subnet mobility to mobility clients utilizing a different, possibly proprietary, client-server based mobility management mechanism.

In accordance with the embodiment of the invention illustrated in FIG. 3, when the home agent receives the registration request from the mobile router, the home agent processes the registration request in accordance with standard Mobile IP, and in addition determines, in accordance with the present invention, whether it may allocate at least one network prefix to the mobile router. If the home agent can grant the registration request, including the request for a network prefix allocation, the home agent allocates one to N network prefixes to the mobile router and communicates this allocation, the corresponding network prefix or network prefixes and the corresponding lease times to the mobile router within a proprietary extension to the Mobile IP registration reply. If the home agent cannot grant the registration request, it sends a registration reply failure to the mobile router, and an attempt to register the mobile router with the home agent can be repeated. A timer is associated with and set according to the lease time that corresponds to each network prefix allocation granted to the mobile router. In essence, the mobile router “leases” one or more subnets from the home agent for the duration of the lease time. As stated above, the lease time is generally not directly affected by the mobile router's Mobile IP registration status.

Once the home agent sends out the registration reply, it may tie all allocated network prefixes to the mobile router using conventional means, and if the home agent is also configured as a router it begin advertising reachability via normal IP dynamic routing protocols for the network prefixes allocated to the mobile router, typically for the duration of the MR-HA registration. Alternatively, the home agent can inform a co-located router which routes are to be advertised. Then once the lease time, i.e., via the corresponding timer, of the mobile router's allocated network prefix expires, the home agent will return the allocated network prefix or network prefixes to the pool of available network prefixes, for instance, from the home agent's assigned address prefix.

Ideally route advertisement is coupled to the registration state versus the subnet lease time. This is useful in certain instances, for example where a mobile router moves to a new home agent before the expiration of the lease time of any allocated network prefixes. In this scenario, it would be desired that route advertisements end upon de-registration with the home agent. Additionally, the lease time may be caused, for instance by the home agent, to expire immediately upon deregistration so that when the mobile router moves to the new home agent it may request one or more topologically correct network prefixes. Otherwise an increased number of routing table entries may be needed to maintain connectivity to the mobile router through routing updates for network prefixes that are specific to the old home agent. This could result in a degradation of service to the mobile router. Moreover, ideally, the network prefixes will come from a larger scoped IPv4 prefix that has been allocated to the home agent. Accordingly most route updates on the part of the home agent will become unnecessary and, thereby, eliminated if the home agent advertises the larger scoped prefix via standard Mobile IP.

Once the mobile router is allocated a network prefix and has allocated a DHCP IP address from that network prefix to, for instance, a stationary host that is coupled to the mobile router, a Correspondent Node (“CN”) may source packets destined to this stationary host. The CN may do this by addressing the packets to the host's DHCP-allocated home address, which the CN may obtain by conventional means. Where the MR's HA is advertising reachability to the network prefix that the MR's host is part of, the packets get routed to the HA. The HA tunnels the packets to the MR via standard Mobile IP encapsulation. The MR may then de-encapsulate the packets and forward them natively to the attached host.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. For example, the present invention has been described with respect to a mobility management system that utilizes Mobile IP. However, it should be understood by those of ordinary skill in the art that the present invention may also be used in systems that use a different client-server based (maybe proprietary) mobility management mechanism. For instance, as long as there is a mobility server in the system that handles mobility management for clients, and as long as the clients inform the mobility server of their IP point of attachment, this invention can be applied. Thus, it should be understood that the invention is not limited by the foregoing description, but embraces all such alterations, modifications and variations in accordance with the spirit and scope of the appended claims.

1. In a system comprising at least one mobility server, at least one mobile router and a plurality of hosts, a method for network prefix allocation comprising the steps of:
detecting a need for at least one network prefix for a mobile router;
sending a registration request message to a mobility server that includes a request to allocate said at least one network prefix to said mobile router; and
receiving a registration reply responsive to said registration request that includes at least one allocated network prefix, wherein said at least one allocated network prefix is reserved for said mobile router for a first time period.

2. The method of claim 1, wherein said at least one network prefix is assigned from a pool of available network prefixes.

3. The method of claim 2, wherein said pool of available network prefixes is pre-allocated to said mobility server.

4. The method of claim 1, wherein said registration request message further includes a request to allocate said at least one network prefix for said first time period.

5. The method of claim 1, wherein said first time period is assigned by said mobility server.

6. The method of claim 5, wherein said first time period is a default time period.

7. The method of claim 1, wherein said at least one allocated network prefix is identified in said registration request message.

8. The method of claim 1 further comprising the step of assigning to at least one host coupled to said mobile router at least one corresponding host address based on said at least one allocated network prefix.

9. The method of claim 8, wherein said at least one corresponding host address is assigned using a Dynamic Host Configuration Protocol.

10. The method of claim 1 further comprising the step of sending a subsequent registration request to said mobility server that includes a request to reserve said at least one allocated network prefix for a second time period that extends beyond said first time period.

11. The method of claim 1, wherein said mobility server is a home agent.

12. In a system comprising at least one home agent, at least one mobile router and a plurality of hosts, a method for network prefix allocation comprising the steps of:
detecting a need for at least one network prefix for a mobile router;
sending a registration request message to a home agent that includes a request to allocate said at least one network prefix to said mobile router; and
receiving a registration reply responsive to said registration request that includes at least one allocated network prefix, wherein said at least one allocated network prefix is reserved for said mobile router for a first time period.

13. In a system comprising at least one mobility server, at least one mobile router and a plurality of hosts, a method for network prefix allocation comprising the steps of:
receiving a registration request message from a mobile router that includes a request to allocate at least one network prefix to said mobile router;
allocating at least one network prefix to said mobile router; and
sending a registration reply to said mobile router responsive to said registration request that includes said at least one allocated network prefix, wherein said at least one allocated network prefix is reserved for said mobile router for a first time period.

14. The method of claim 13 further comprising setting a timer for a time equal to said first time period.

15. The method of claim 14 further comprising returning said at least one allocated network prefix to a pool of available network prefixes upon the expiration of said timer.

16. The method of claim 15, wherein said pool of available network prefixes is pre-allocated to said mobility server.

17. The method of claim 13 further comprising the step of advertising reachability via internet protocol (IP) dynamic routing protocols for said at least one allocated network prefix.

18. The method of claim 13, wherein said mobility server is a home agent.

19. The method of claim 13, wherein said registration request message further includes a request to allocate said at least one network prefix for said first time period.

20. The method of claim 13, wherein said first time period is assigned by said mobility server.

21. The method of claim 20, wherein said first time period is a default time period.

22. The method of claim 13, wherein said at least one allocated network prefix is identified in said registration request message.

23. A mobile router configured for performing the method of claim 1.

24. A mobility server configured for performing the method of claim 13.
